(19) United States
(12) Patent Application Publication
(10) Pub. No.: US 2012/0021369 A1
(43) Pub. Date: Jan. 26, 2012

(54) PERIODONTAL DISEASE SPACE MAINTENANCE DEVICES AND METHODS

(75) Inventor: William F. McKay, Memphis, TN (US)

(73) Assignee: WARSAW ORTHOPEDIC, INC., Warsaw, IN (US)

(21) Appl. No.: 12/839,934

(22) Filed: Jul. 20, 2010

(51) Int. Cl. A61C 19/06

(52) U.S. Cl. 433/25; 433/215

(57) ABSTRACT

Devices and methods are provided for maintaining space to treat a periodontal defect adjacent to a tooth, the devices and methods comprise a supporting structure comprising a pin, or suture or mesh having a body configured to extend over the periodontal defect and hold gingival tissue above the defect, the supporting structure having a first end configured to retain the supporting structure against at least a portion of the tooth and a second end configured to be attached or implanted in or on at least a portion of bone adjacent to the periodontal defect. The devices and methods provided maintain space between at least gingival tissue and the periodontal ligament and avoid compression of any bone replacement material in the defect. In some embodiments, the devices and methods provided can be removed from the healed periodontal defect without the need to cut into healed soft tissue.

### BACKGROUND

During the early stages of periodontal disease, known commonly as gingivitis, bacteria on the teeth and near the gingiva infect and irritate the sulcus where the gingiva approximates the tooth. The presence of bacteria can lead to destruction of the gingival epithelium which connects the gingiva to the tooth and can force the epithelium to separate from the root of the tooth. Also, as a result of bacterial presence, inflammatory cells increasingly populate the gingival tissues. Thus, the tissue is weaker due to the disease, and attachment is lessened. Of course, further infection moves the tissue attachment further toward the apex of the tooth, creating a pathological pocket much deeper than the normal sulcus.

Naturally, this pocket is difficult to clean or floss because the routine cleaning instruments of normal home care cannot reach the bacteria or plaque, which accumulate within the pocket. As disease extends the pocket, the periodontal ligament which attaches the tooth to the supporting bone, and the supporting alveolar bone itself, are destroyed. This disease leaves a periodontal defect, filled with plaque and bacteria. Ultimately, the tooth could be surrounded by loose, diseased, and detached gingiva. Eventually such deterioration can result in the loss of the tooth.

One conventional treatment of periodontal defects involves surgically gaining access to the tooth root surface in an effort to remove bacteria and possible infected soft tissue and to alter the periodontal pocket or obtain reattachment of the connective tissue toward the crown of the tooth. Some of the former methods accomplish this attachment by cutting away gingival tissue near the crown of the tooth and, if necessary, shaping underlying bone to create a sulcus similar in depth to a normal sulcus so that regular oral hygiene may be used to maintain attachment of the gingiva to the tooth. Of course, such treatment does not recreate the attachment of the gingiva near the crown like that which existed before any diseased condition. Such treatment also does not replace any periodontium lost to disease.

Another conventional treatment for periodontal disease involves gingival flap surgical procedures, where one or more flaps of gingival tissue are retracted from the tooth. After the tooth root is thoroughly cleaned, and diseased soft tissue is removed, these flaps are reopposed to the tooth. In some instances bone replacement material (e.g., bone grafts, alveolar bone cells, and/or periodontal ligament tissue, etc.) from other portions of the mouth are incorporated into the periodontal defect. Typically, after periodontal surgery, a race begins among the cells from the four types of periodontal tissues, gingival epithelium, gingival connective tissue, alveolar bone and periodontal ligament, to repopulate the previously diseased root surface.

Gingival epithelium and gingival connective tissue cells migrate rapidly along the tooth root toward the apex of the tooth, while alveolar bone cells, bone cementum cells, and periodontal ligament cells migrate much more slowly. If the gingival tissue is allowed to migrate in an uncontrolled way toward the base of the periodontal defect, the gingival tissue will compress the bone replacement material and it will not retain its shape. Further, downgrowth of gingival epithelium and gingival connective tissue cells into the periodontal defect will reduce migration of alveolar bone cells, bone cementum cells, and periodontal ligament cells and inhibit proper healing of the defect. Therefore, gingival flap surgical procedures tend to be unpredictable.

Therefore, there is a need for devices and methods that reduce gingival epithelium and gingival connective tissues from compressing bone replacement material in the periodontal defect. Further there is a need for devices and methods that reduce the number of surgical procedures required to cut into gingival tissue that has already healed.

### SUMMARY

Devices and methods are provided that reduce gingival epithelium and gingival connective tissues from compressing bone replacement material in the periodontal defect.

In some embodiments, the devices and methods provided reduce the number of surgical procedures required to cut into gingival tissue that has healed from prior surgeries.

In some embodiments, the devices and methods utilize guided tissue regeneration where the cementum, alveolar bone and periodontal ligament producing cells have the ability to become established on the tooth root surface by maintaining space and isolating the tooth root surface from gingival epithelium and gingival connective tissues, and fibroblast cells during healing. This type of space maintenance and isolation enhances migration of alveolar bone cells, bone cementum cells, and periodontal ligament cells for proper healing of the periodontal defect.

In one embodiment, there is a device for maintaining space to treat a periodontal defect adjacent to a tooth, the device comprising a supporting structure having a body configured to extend over the periodontal defect and hold gingival tissue above the defect, the supporting structure having a first end configured to retain the supporting structure against at least a portion of the tooth and a second end implanted in or on at least a portion of bone adjacent to the periodontal defect, wherein the body of the supporting structure maintains space between at least gingival tissue and a periodontal ligament.

In another embodiment, there is a device for maintaining space to treat a periodontal defect adjacent to a tooth, the device comprising a mesh or suture having a body configured to extend over the periodontal defect and hold gingival tissue above the defect, the mesh or suture having a first end configured to retain the mesh or suture against at least a portion of the tooth and a second end having anchoring members configured to be implanted in or on at least a portion of bone adjacent to the periodontal defect, wherein the body of the mesh or suture maintains space between gingival tissue and a periodontal ligament.

In yet another embodiment, there is a method for treating a periodontal defect adjacent to a tooth, the method comprising separating soft tissue from at least a portion of the tooth located at the periodontal defect; providing a device comprising a supporting structure having a body configured to extend over the periodontal defect and hold gingival tissue above the defect, the supporting structure having a first end configured to retain the supporting structure against at least a portion of the tooth and a second end implanted in or on at least a portion of bone adjacent to the periodontal defect; and placing the first end of the supporting structure against at least the portion of the tooth and implanting the second end of the rod in or on at least the portion of the bone adjacent to the periodontal defect so as to extend the body over the periodontal defect and hold gingival tissue above the defect, wherein the body of the supporting structure maintains space between gingival tissue and a periodontal ligament.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE FIGURES

In part, other aspects, features, benefits and advantages of the embodiments will be apparent with regard to the following description, appended claims and accompanying drawings where:

FIG. 1 is a schematic top view of an embodiment of a device to maintain space between soft tissue and the periodontal defect. The device comprises a rod having a suture at a first end.

FIG. 2 is a schematic side view of an embodiment of a device to maintain space between soft tissue and the periodontal defect. The device comprises a pin having a suture at a first end fastened to the tooth adjacent to the periodontal defect and the second end of the pin is implanted into bone to maintain space above the periodontal defect.

FIG. 3 is a schematic top view of an embodiment of a device to maintain space between soft tissue and the periodontal defect. The device comprises a pin having a suture at a first end fastened to the tooth adjacent to the periodontal defect and the second end of the pin is implanted into bone to maintain space above the periodontal defect.

FIG. 4 is a schematic side view of an embodiment of a device to maintain space between soft tissue and the periodontal defect. The device comprises a pin disposed in a post, which is attached to the tooth adjacent to the periodontal defect and the second end of the pin is implanted into bone to maintain space above the periodontal defect.

FIG. 5 is a schematic top view of an embodiment of a device to maintain space between soft tissue and the periodontal defect. The device comprises two pins disposed in or on two separate posts, which are attached to the tooth adjacent to the periodontal defect and implanted into bone above bone replacement material to maintain space above the periodontal defect.

FIG. 6 is a schematic top view of an embodiment of a device to maintain space between soft tissue and the periodontal defect. The device comprises two pins disposed in or on two separate posts, which are attached to the tooth adjacent to the periodontal defect and implanted into bone to maintain space above the periodontal defect. The two pins have a mesh disposed therebetween to increase surface area so that the pins can provide more space and hold more soft tissue away from the periodontal defect.

FIG. 7 is a schematic top view of an embodiment of a device to maintain space between soft tissue and the periodontal defect. The device comprises a pin having a flexible first end that is forced against the tooth adjacent to the periodontal defect and the second end of the pin is implanted into bone to maintain space above the periodontal defect. The pin has struts coming from its body to increase surface area so that it creates more space and holds more soft tissue away from the periodontal defect.

FIG. 8 is a schematic side view of an embodiment of a device to maintain space between soft tissue and the periodontal defect. The device comprises a mesh having a suture at a first end fastened to the tooth adjacent to the periodontal defect and the second end of the mesh is implanted into bone using screws. The mesh increases surface area so that it creates more space and holds more soft tissue away from the periodontal defect.

It is to be understood that the figures are not drawn to scale. Further, the relation between objects in a figure may not be to scale, and may in fact have a reverse relationship as to size. The figures are intended to bring understanding and clarity to the structure of each object shown, and thus, some features may be exaggerated in order to illustrate a specific feature of a structure.

### DETAILED DESCRIPTION

For the purposes of this specification and appended claims, unless otherwise indicated, all numbers expressing quantities of ingredients, percentages or proportions of materials, reaction conditions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding the numerical ranges and parameters set forth herein, the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a range of “1 to 10” includes any and all subranges between (and including) the minimum value of 1 and the maximum value of 10, that is, any and all subranges having a minimum value of equal to or greater than 1 and a maximum value of equal to or less than 10, e.g., 5.5 to 10.

Reference will now be made in detail to certain embodiments of the invention, examples of which are illustrated in the accompanying drawings. While the invention will be described in conjunction with the illustrated embodiments, it will be understood that they are not intended to limit the invention to those embodiments. On the contrary, the invention is intended to cover all alternatives, modifications, and equivalents that may be included within the invention as defined by the appended claims.

The headings below are not meant to limit the disclosure in any way; embodiments under any one heading may be used in conjunction with embodiments under any other heading.

### Definitions

It is noted that, as used in this specification and the appended claims, the singular forms “a,” “an,” and “the,” include plural referents unless expressly and unequivocally limited to one referent. Thus, for example, reference to “a rod” includes one, two, three or more rods.

The term “practitioner” or “user” means a person who is using the methods and/or devices of the current disclosure on the patient. This term includes, without limitation, doctors (e.g., surgeons, interventional specialists, physicians), nurses, nurse practitioners, other medical personnel, clinicians, dentists, veterinarians, or scientists.

The term “mammal” refers to organisms from the taxonomy class “mammalian,” including but not limited to humans, other primates such as chimpanzees, apes, orangutans and monkeys, rats, mice, cats, dogs, pigs, cows, horses, etc. In various embodiments, the mammal is a human patient.

“Periodontal disease” includes any condition that affects the gums and other structures supporting the teeth. The most common form of periodontal disease is caused by bacterial infections. These bacteria grow in a sticky film called dental plaque that sticks on the tooth surfaces next to the gums. The bacteria can cause inflammation, spread and destroy the gums and the supporting bone around the teeth. The mildest form of periodontal disease is gingivitis, which affects only the gums. More severe periodontal disease damages the other supporting structures including the periodontal ligament and/or bone structure of the tooth or alveolar bone, referred to herein as “periodontal defect.”

The term support structure includes a device that is configured to extend configured to extend over the periodontal defect and hold tissue above the defect. A support structure includes, but is not limited to, a rod, a mesh, a web, strut, or the like.

The term “rod” includes a thin piece of material including a stick, plate, shaft, wand, board, bar, pin or other elongated structure that can be rounded or flat.

The term “therapeutic agent” may be used interchangeably herein with the terms “drug,” “therapeutically effective amount,” and “active pharmaceutical ingredient” or “API.” It will be understood that unless otherwise specified a “therapeutic agent” formulation may include more than one therapeutic agent, wherein exemplary combinations of therapeutic agents include a combination of two or more drugs. The therapeutic agent provides a concentration gradient of the therapeutic agent for delivery to the site.

A “therapeutically effective amount” or “effective amount” is such that when administered, the drug results in alteration of the biological activity, such as, for example, inhibition of inflammation, reduction or alleviation of periodontal disease, etc.

The term “biodegradable” includes that all or parts of the material will degrade over time by the action of enzymes, by hydrolytic action and/or by other similar mechanisms in the oral cavity. In various embodiments, “biodegradable” includes that the material can break down or degrade within the oral cavity to non-toxic components after or while a therapeutic agent has been or is being released. By “bioerodible” it is meant that the material or portion thereof will erode or degrade over time due, at least in part, to contact with substances found in the surrounding tissue, fluids or by cellular action. By “bioresorbable” it is meant that the material or portion thereof will be broken down and resorbed within the human body, for example, by a cell or tissue. “Biocompatible” means that the material will not cause substantial tissue irritation or necrosis at the target tissue site.

“Treating” or “treatment” of a disease or condition refers to executing a protocol that may include administering one or more devices and/or drugs to a patient (human, normal or otherwise or other mammal), in an effort to alleviate signs or symptoms of the disease or condition. Alleviation can occur prior to signs or symptoms of the disease or condition appearing, as well as after their appearance. Thus, treating or treatment includes preventing or prevention of disease or undesirable condition (e.g., preventing the disease from occurring in a patient, who may be predisposed to the disease but has not yet been diagnosed as having it). In addition, treating or treatment does not require complete alleviation of signs or symptoms, does not require a cure, and specifically includes protocols that have only a marginal effect on the patient. Treatment can include inhibiting the disease, e.g., arresting its development; or relieving the disease, e.g., causing regression of the disease. For example, treatment can include reducing acute or chronic inflammation; alleviating pain and mitigating and inducing re-growth of new periodontal ligament, bone and other tissues; as an adjunct in orthognathic surgery; any elective cosmetic surgical or repair procedure or so forth.

### Space Maintenance Devices

Devices and methods are provided that reduce gingival epithelium and gingival connective tissues from compressing bone replacement material in the periodontal defect.

In some embodiments, the devices and methods provided reduce the number of surgical procedures required to cut into gingival tissue that has healed from prior surgeries. In some embodiments, the device and methods utilize guided tissue regeneration where the cementum, alveolar bone and periodontal ligament producing cells have the ability to become established on the tooth root surface by maintaining space and isolating the tooth root surface from gingival epithelium and gingival connective tissues during healing. This type of space maintenance and isolation enhances migration of alveolar bone cells, bone cementum cells, and periodontal ligament cells for proper healing of the periodontal defect.

In one embodiment, there is a device for maintaining space to treat a periodontal defect adjacent to a tooth, the device comprising a rod having a body configured to extend over the periodontal defect and hold gingival tissue above the defect, the rod having a first end configured to retain the rod against at least a portion of the tooth and a second end implanted in at least a portion of bone adjacent to the periodontal defect, wherein the body of the rod maintains space between at least gingival tissue and a periodontal ligament.

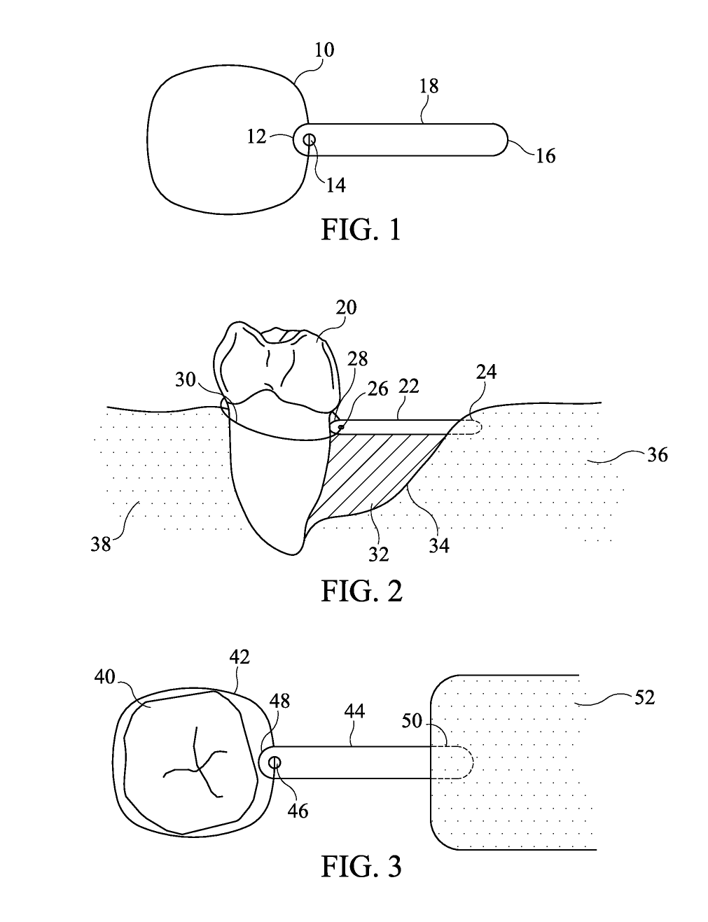

Referring to FIG. 1, it is a schematic top view of an embodiment of a device to maintain space between soft tissue and the periodontal defect. The device comprises a support structure shown as a rod having a body 18 configured to extend over the periodontal defect and hold gingival tissue above the defect, the rod having a first end 12 configured to retain the rod against at least a portion of the tooth. In this embodiment, the first end 12 of the rod is configured to have a suture 10 disposed in the first end 12 through a suture hole or channel 14, which receives the suture 10. The practitioner fastens this part of the rod onto the tooth or tooth surface. Although the rod is shown having a hole or channel 14 in it, in various embodiments, the rod can have one or more channels, grooves, slits, loops, hooks, and/or barbs that can be larger than #000000, #00, #0, #1, #2, #3, #4, #5, or #6, range so that the suture can pass through the surface of the rod.

It will be understood by those of ordinary skill in the art that although a suture is shown, other suture means can be used, such as for example, a yarn, thread, line, wire, or the like. Unlike prior art devices, the present device is a novel way of treating periodontal defects by placing the device next to the tooth.

The second end 16 of the rod is shown as a blunt end and can be implanted into a portion of bone adjacent to the periodontal defect. In some embodiments, a hole can be drilled into the bone first before the second end of the rod is inserted. In other embodiments, the rod can have a point and pierce bone with or without first drilling.

The rod can be a thin piece of material including a stick, plate, shaft, wand, board, bar pin, or other elongated structure that can be flat or rounded. The rod can have its surface area maximized for optimum soft tissue holding and space maintenance. In some embodiments, the rod can be from about 1 mm to about 10 mm, or from about 3 mm to about 10 mm in length and from about 0.25 mm to about 1.0 mm in diameter. The rod is configured for maintaining space and isolating the tooth root surface from gingival epithelium and gingival connective tissues during healing. This type of space maintenance and isolation enhances migration of alveolar bone cells, bone cementum cells, and periodontal ligament cells for proper healing of the periodontal defect. In some embodiments, the rod maintains from about 0.5 mm to about 20 mm of space between the soft tissue and the periodontal ligament.

The rod can be made of metal, plastic, or ceramic or a combination thereof. The rod can be made of rigid or flexible material or a combination thereof. In some embodiments, the rod may comprise polyurethane, polyurea, polyether(amide), PEBA, thermoplastic elastomeric olefin, copolyester, and styrenic thermoplastic elastomer, polypropylene, nylon, rubber, steel, aluminum, stainless steel, titanium, metal alloys with high non-ferrous metal content and a low relative proportion of iron, carbon fiber, glass fiber, plastics, ceramics or combinations thereof. The rod can be the same or different colors or can be transparent or combinations thereof.

The suture may be resorbable or permanent in nature depending upon the type of material from which it is made. As used herein, “suture” refers to any flexible structure that can be stretched between two points and includes, without limitation, traditional suture material, single or multiple stranded threads, or a mesh structure. Sutures may be made from silk, nylon, linen, cotton, chromic gut, plain gut, cat gut, vicryl, polyglactin, polyester, polypropylene, stainless steel, synthetic polymers having glycolic acid ester linkages subject to hydrolytic degradation to non-toxic tissue compatible absorbable components, including polyglycolic acid. The sutures may be monofilamentary or braided, absorbable or non-absorbable. The suture may be of any length. In various embodiments, the suture is long enough to be fastened around the tooth.

In some embodiments, the suture may be a preformed loop or string extending from the rod. The suture may be of any thickness provided it can be attached to or pass through the tooth or bone. In some embodiments, the suture may be thick to provide a maximized surface area for optimum soft tissue holding and space maintenance. In some embodiments, the diameter of the suture is about 0.25 mm to about 1mm to hold the soft tissue. In some embodiments, the rod and or suture may contain a therapeutic agent disposed within or on it.

A variety of bioabsorbable polymers can be used to make the suture. Examples of suitable biocompatible, bioabsorbable polymers include aliphatic polyesters, poly(amino acids), copoly(ether-esters), polyalkylenes oxalates, polyamides, tyrosine derived polycarbonates, poly(iminocarbonates), polyorthoesters, polyoxaesters, polyamidoesters, polyoxaesters containing amine groups, poly(anhydrides), polyphosphazenes, biomolecules (i.e., biopolymers such as collagen, elastin, bioabsorbable starches, etc.) or blends thereof. Polyesters include, but are not limited to, homopolymers and copolymers of lactide (which includes lactic acid, D-,L- and meso lactide), glycolide (including glycolic acid), caprolactone, p-dioxanone (1,4-dioxan-2-one), trimethylene carbonate (1,3-dioxan-2-one), alkyl derivatives of trimethylene carbonate, delta-valerolactone, beta-butyrolactone, gamma-butyrolactone, epsilon-decalactone, hydroxybutyrate, hydroxyvalerate, 1,4-dioxepan-2-one (including its dimer 1,5,8,12-tetraoxacyclotetradecane-7,14-dione), 1,5-dioxepan-2-one, 6,6-dimethyl-1,4-dioxan-2-one 2,5-diketomorpholine, pivalolactone, alpha-diethylpropiolactone, ethylene carbonate, ethylene oxalate, 3-methyl-1,4-dioxane-2,5-dione, 3,3-diethyl-1,4-dioxan-2,5-dione, 6,8-dioxabicycloctane-7-one or polymer blends thereof.

In some embodiments, the suture can comprise shape memory polymers including various polyethers, polyacrylates, polyamides, polysiloxanes, polyurethanes, polyether amides, polyurethane/ureas, polyether esters, or urethane/butadiene copolymers or a combination thereof.

Sutures may be of different sizes depending on the procedure being performed. Sutures can range in size from #000000 (#6-0 or #6/0), #00 (#2-0 or #2/0), #0, #1, #2, #3, #4, #5, #6, with #000000 being the smallest.

FIG. 2 is a schematic side view of an embodiment of a device to maintain space between soft tissue and the periodontal defect 34. The device comprises a pin having a body 22 configured to extend over the periodontal defect 34 and hold gingival tissue above the defect, the pin having a first end 26 configured to retain the pin against at least a portion of the tooth 20. In this embodiment shown, the first end 26 of the pin is configured to have a suture 30 disposed in the first end 26 through a suture hole or channel 28, which receives the suture 30. The practitioner fastens first end 26 of the pin onto the tooth 20 or tooth surface.

The second end 24 of the pin is shown as a blunt end and can be implanted into a portion of bone 36 adjacent to the periodontal defect. In some embodiments, a hole can be drilled into the bone first before the second end of the rod is inserted. In other embodiments, the rod can have a point and pierce bone with or without first drilling. Here bone replacement material 32 (e.g., bone grafts, alveolar bone cells, and/or periodontal ligament tissue, etc.) is placed in the defect to aid in re-growing the slow growing alveolar bone, and/or periodontal ligament. The bone replacement material 32 can be placed before, during or after the pin is implanted. When the periodontal defect is successfully repaired the alveolar bone, and/or periodontal ligament will be regenerated as shown in 38.

In the embodiment shown in FIG. 2, the pin is extending above and horizontally over the defect. The pin functions to isolate and maintain space above the periodontal defect. This space and isolation during the initial healing process will reduce migration of gingival epithelium cells, gingival connective tissue cells, and/or other soft tissue cells and enables the periodontal ligament to become re-established in a proper sequence resulting in a new periodontal attachment. It will also allow cementum cells, periodontal ligament producing cells and alveolar bone cells to migrate in and permit ingrowth of periodontal ligament and alveolar bone to repair the periodontal defect.

It should be understood by one of ordinary skill in the art that the pin can be one piece. Alternatively, the pin can be two or more separate pieces that are attached together by any attachment means (e.g. adhesive, snap-fit junction, push fitting, mating pairs, screw and thread fitting, etc.) so that it can be customized to extend over the defect. In some embodiments, the pin can have telescoping length and/or width to adjust to the size of the defect.

After the periodontal defect has healed, the gingival epithelium cells, and gingival connective tissue or other soft tissue will cover the pin (e.g., usually in a few weeks or months after the device is placed over the defect). In a subsequent visit, the practitioner in a minimally invasive procedure can simply remove the suture on the tooth and pull the pin out of the now healed defect and there will be no need for subsequent surgeries that cut into the healed soft tissue to remove the device. Therefore, pain and discomfort to the patient is reduced and there is less need for invasive surgical procedures.

Referring to FIG. 3, it is a schematic top view of an embodiment of a device to maintain space between soft tissue and the periodontal defect. The device comprises a pin having a body 44 configured to extend over the periodontal defect and hold gingival tissue above the defect, the pin having a first end 46 configured to retain the pin against at least a portion of the tooth 40 or tooth surface. In this embodiment shown, the first end 46 of the pin is configured to have a suture 42 disposed in the first end 46 through a suture hole 48, which receives the suture 42. The practitioner fastens first end 46 of the pin onto the tooth 40 or tooth surface.

The second end 50 of the pin is shown as a blunt end and can be implanted into a portion of bone 52 adjacent to the periodontal defect. In some embodiments, a hole can be drilled into the bone first before the second end of the pin is inserted. In other embodiments, the pin can have a point and pierce bone with or without first drilling. In some embodiments, the pin can have its surface area maximized for optimum soft tissue holding and space maintenance.

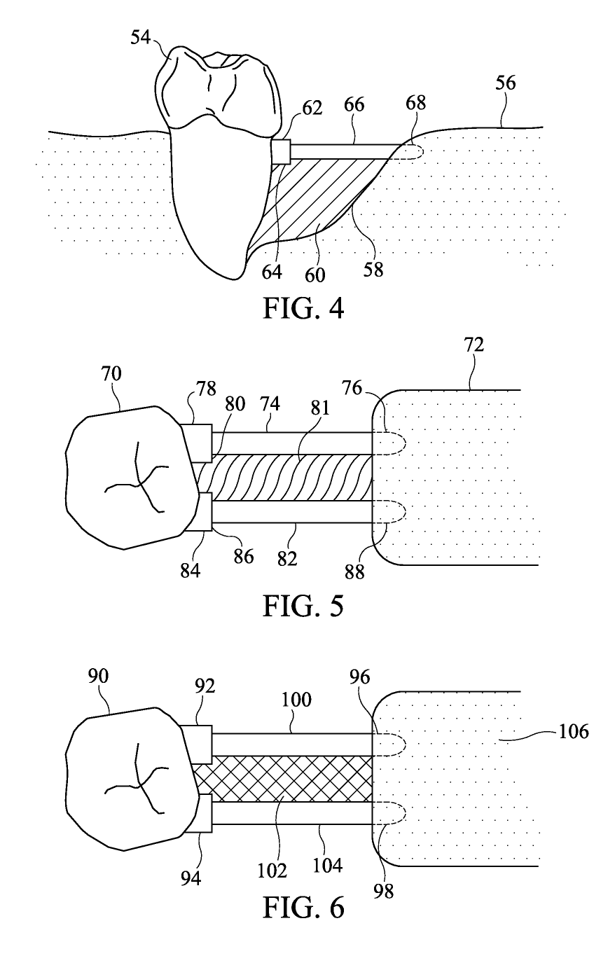

Referring to FIG. 4, it is a schematic side view of an embodiment of a device to maintain space between soft tissue and the periodontal defect 58. The device comprises a pin having a body 66 configured to extend over the periodontal defect 58 and hold gingival tissue above the defect, the pin having a first end 64 configured to retain the pin against at least a portion of the tooth 54.

In this embodiment shown, the first end 64 of the pin is configured to be disposed in or on a post 62 disposed on a tooth surface using, for example, an adhesive that is disposed on a surface of the post 62 or the surface of the tooth to secure the post on the tooth. The post 62 is configured to receive the first end 64 of the pin so that it is secured to the tooth. In some embodiments, the post has a channel to receive the pin, in other embodiments, the pin can be pushed or snapped into the post, or there are channels, grooves, slits, loops, hooks, or barbs that allow the pin to engage the post and retain the post in position. In some embodiments, the pin is glued to the post. In some embodiments, the pin and the post can be one piece.

In some embodiments, there is no post and the first end 64 can be glued directly to the tooth surface. This embodiment is the “post-less” design. In some embodiments, the pin has one or more enlarged ends to allow gluing to the tooth surface or bone and the body will be smaller than the one or more enlarged ends.

The second end 68 of the pin is shown as a blunt end and can be implanted into a portion of bone 56 adjacent to the periodontal defect. In some embodiments, a hole can be drilled into the bone first before the second end of the pin is inserted. In other embodiments, the pin can have a point and pierce bone with or without first drilling. Here bone replacement material 60 (e.g., bone grafts, alveolar bone cells, and/or periodontal ligament tissue, etc.) is placed in the defect to aid in re-growing the slow growing alveolar bone, and/or periodontal ligament. The bone replacement material 60 can be placed before, during or after the pin is implanted.

When the periodontal defect is successfully repaired the alveolar bone, and/or periodontal ligament will be continuous. In the embodiment shown in FIG. 4, the pin is extending above and horizontally over the defect.

After the periodontal defect has healed, the gingival epithelium cells, and gingival connective tissue or other soft tissue will cover the pin and/or post (e.g., usually in a few weeks or months after the device is placed over the defect). In a subsequent visit, the practitioner in a minimally invasive procedure can simply remove the pin and the post on the tooth, for example with an adhesive remover, and pull the pin out of the now healed defect and there will be no need for subsequent surgeries that cut into the healed soft tissue to remove the device.

Referring to FIG. 5, it is a schematic side view of an embodiment of a device to maintain space between soft tissue and the periodontal defect. The device comprises two supporting structures shown as pins having bodies 74 and 82 configured to extend over the periodontal defect and hold gingival tissue above the defect, the pins have first ends 80 and 86 configured to retain the pins against at least a portion of the tooth 70.

In this embodiment shown, the first ends 80 and 86 of the pins are configured to be disposed in or on posts 78 and 84 disposed on a tooth surface using, for example, an adhesive that is disposed on a surface of each post or the surface of the tooth to secure the posts on the tooth. The posts 78 and 84 are configured to receive the first ends 80 and 86 respectively of the pins so that they are secured to the tooth. In some embodiments, the posts have channels to receive the pins, in other embodiments, the pins can be pushed or snapped into the post, or there are channels, grooves, slits, loops, hooks, or barbs that allow the pins to engage the posts and retain the posts in position. In some embodiments, the pins are glued to the posts. In some embodiments, the pins and the posts can be one piece. In some embodiments, the post is one piece with two fittings for the two pins to engage the post and be secured to it.

The second ends 76 and 88 of the pins are shown as blunt ends and can be implanted into or attached to a portion of bone 72 adjacent to the periodontal defect. In some embodiments, the second ends 76 and 88 engage bone 72 on its surface by being attached to it using an adhesive. In some embodiments, a hole can be drilled into the bone first before the second ends 76 and 88 of the pins are inserted. In other embodiments, the pins can have a point and pierce bone with or without first drilling. In some embodiments the second ends 76 and 88 can be angled upward or downward in relation to the bone for ease of insertion and removal.

By using two pins, and posts, they function to further isolate and maintain space above the periodontal defect because of the increased surface area, as compared to embodiments with one post or pin. This increased space and isolation during the initial healing process will reduce migration of gingival epithelium cells, gingival connective tissue cells, and/or other soft tissue cells and enables the periodontal ligament to become re-established in a proper sequence resulting in a new periodontal attachment. It will also allow cementum cells, periodontal ligament producing cells and alveolar bone cells to migrate in and permit ingrowth of periodontal ligament and alveolar bone to repair the periodontal defect. It will also prevent or inhibit the bone replacement material 81 (e.g., graft material) from being compressed.

After the periodontal defect has healed, the gingival epithelium cells, and gingival connective tissue or other soft tissue will cover the pins and/or posts (e.g., usually in a few weeks or months after the device is placed over the defect). In a subsequent visit, the practitioner in a minimally invasive procedure can simply remove the pins and the posts on the tooth, for example with an adhesive remover, and pull the pins out of the now healed defect and there will be no need for subsequent surgeries that cut in the healed soft tissue to remove the device.

Referring to FIG. 6, it is a schematic side view of an embodiment of a device to maintain space between soft tissue and the periodontal defect. The device comprises two support structures shown as pins having bodies 100 and 104 configured to extend over the periodontal defect and hold gingival tissue above the defect, the pins have first ends configured to retain the pins against at least a portion of the tooth 90.

In this embodiment shown, the first ends of the pins are configured to be disposed in or on posts 92 and 94 disposed on a tooth surface with, for example, an adhesive that is disposed on a surface of each post or the surface of the tooth to secure the posts on the tooth. The posts 92 and 94 are configured to receive the first ends of the pins so that they are secured to the tooth. In some embodiments, the posts have channels to receive the pins, in other embodiments, the pins can be pushed or snapped into the post, or there are channels, grooves, slits, loops, hooks, or barbs that allow the pins to engage the posts and retain the posts in position. In some embodiments, the pins are glued to the posts. In some embodiments, the pins and the posts can be one piece. In some embodiments, the post is one piece with two fittings for the two pins to engage the post and be secured to it.

The second ends 96 and 98 of the pins are shown as a blunt end and can be implanted into or attached to a portion of bone 106 adjacent to the periodontal defect. In some embodiments, the second ends 96 and 98 engage bone 106 on its surface by being attached to it using an adhesive. In some embodiments, a hole can be drilled into the bone first before the second ends 96 and 98 of the pins are inserted. In other embodiments, the pins can have a point and pierce bone with or without first drilling.

Between the pins, is another support structure shown as a mesh or web that is disposed and shown as 102. The mesh or web is attached to each pin and functions to further isolate and maintain space above the periodontal defect because of the increased surface area, as compared to embodiments with one or two posts or pins. This increased space and isolation during the initial healing process will reduce migration of gingival epithelium cells, gingival connective tissue cells, and/or other soft tissue cells and enables the periodontal ligament to become re-established in a proper sequence resulting in a new periodontal attachment. It will also allow cementum cells, periodontal ligament producing cells and alveolar bone cells to migrate in and permit ingrowth of periodontal ligament and alveolar bone to repair the periodontal defect.

After the periodontal defect has healed, the gingival epithelium cells, and gingival connective tissue or other soft tissue will cover the pin, post and the mesh (e.g., usually in a few weeks or months after the device is placed over the defect). In a subsequent visit, the practitioner in a minimally invasive procedure can simply remove the pin, post and the mesh (if the mesh is not biodegradable) out of the now healed defect and there will be no need for subsequent surgeries that cut into the healed soft tissue to remove the device.

In some embodiments, the mesh or web comprises fibers in either a random, or organized fashion, threads, yarns, nets, knits, weaves, laces, felts of fibers, sheets, membranes, and/or foam, which will allow certain cell ingrowth (e.g., alveolar bone cells, bone cementum cells, cementoblasts, periodontal ligament cells). The mesh or web will reduce passage of gingival epithelium cells, gingival connective tissue cells, other soft tissue cells, fibroblasts, mast cells, neutrophils, monocytes, lymphocytes, eosinophils, basophils, proteoglycans, and/or inflammatory components that may impair healing of the periodontal defect. In some embodiments, the mesh or web has a thickness of about 0.1 mm to about 0.5 mm.

The mesh or web is typically porous so long as the pore sizes are small enough to substantially preclude certain cell passage and ingrowth. Such a porous mesh or web may be advantageous for certain applications, for example, where passage of nutrients or gasses across the mesh is important.

The mesh or web may be made of non-biodegradable material, such as for example, polyurethane, polyurea, polyether(amide), PEBA, thermoplastic elastomeric olefin, copolyester, and styrenic thermoplastic elastomer, polypropylene, nylon, rubber, steel, aluminum, stainless steel, titanium, metal alloys with high non-ferrous metal content and a low relative proportion of iron, carbon fiber, glass fiber, plastics, ceramics or combinations thereof.

In some embodiments, the mesh or web may be biodegradable and comprise natural or synthetic polymers. In some embodiments, the mesh or web comprises poly(alpha-hydroxy acids), poly(lactide-co-glycolide) (PLGA), polylactide (PLA), polyglycolide (PG), polyethylene glycol (PEG) conjugates of poly(alpha-hydroxy acids), poly(orthoester)s (POE), polyaspirins, polyphosphagenes, collagen, starch, pre-gelatinized starch, hyaluronic acid, chitosans, gelatin, alginates, albumin, fibrin, vitamin E analogs, such as alpha tocopheryl acetate, d-alpha tocopheryl succinate, D,L-lactide, or L-lactide, .-caprolactone, dextrans, vinylpyrrolidone, polyvinyl alcohol (PVA), PVA-g-PLGA, PEGT-PBT copolymer (polyactive), methacrylates, poly(N-isopropylacrylamide), PEO-PPO-PEO (pluronics), PEO-PPO-PAA copolymers, PLGA-PEO-PLGA, PEG-PLG, PLA-PLGA, poloxamer 407, PEG-PLGA-PEG triblock copolymers, SAIB (sucrose acetate isobutyrate) or combinations thereof. As persons of ordinary skill are aware, mPEG may be used as a plasticizer for PLGA, but other polymers/excipients may be used to achieve the same effect. In some embodiments, the mesh comprises poly(lactide-co-glycolide) (PLGA), polylactide (PLA), polyglycolide (PGA), D-lactide, D,L-lactide, L-lactide, D,L-lactide-ε-caprolactone, D,L-lactide-glycolide-ε-caprolactone or a combination thereof.

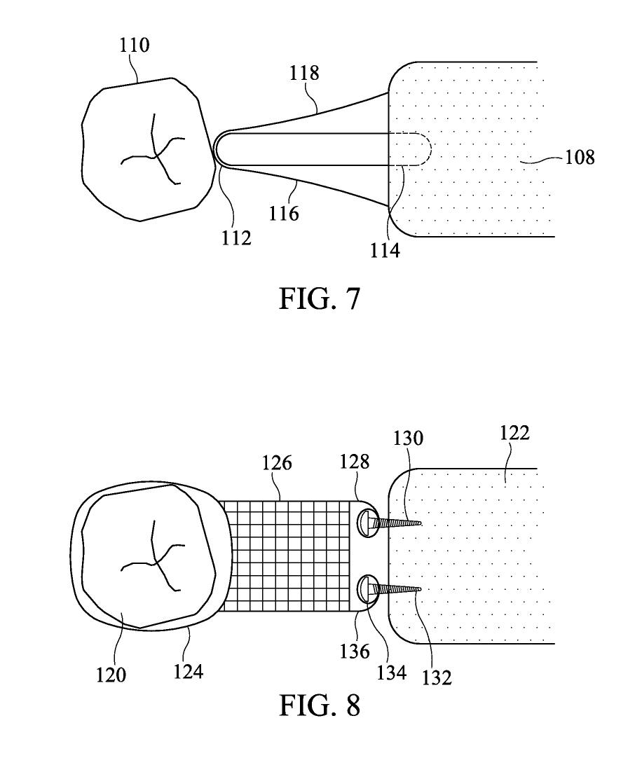

Referring to FIG. 7, it is a schematic top view of an embodiment of a device to maintain space between soft tissue and the periodontal defect. The device comprises a pin having a body configured to extend over the periodontal defect and hold gingival tissue above the defect, the pin having a first end 112 configured to retain the pin against at least a portion of the tooth 110 or tooth surface. In this embodiment shown, the first end 112 of the pin is flexible and is forced against the tooth. Alternatively, the first end of the pin can be attached to the tooth with an adhesive. The pin has left and right struts 116 and 118 running longitudinally with the pin and starting at the first end of the pin 112. In some embodiments the struts are structural components designed to resist longitudinal compression. In some embodiments the struts increase surface area as well as space and hold soft tissue above the periodontal defect. Like the pin 112, the struts 116 and 118 can be rigid or flexible. The struts can be glued to the bone 108 or tooth 112, or they can be implanted into the bone or tooth. It will be understood by those of ordinary skill in the art that the struts can be disposed anywhere on the pin.

In use, the practitioner fastens first end 112 of the pin onto the tooth 110 or tooth surface by implanting, with an adhesive or by forcing the flexible portion of the first end 112 against the tooth surface.

The second end 114 of the pin is shown as a blunt end and can be implanted into a portion of bone 108 adjacent to the periodontal defect. In some embodiments, a hole can be drilled into the bone first before the second end of the pin is inserted. In other embodiments, the pin can have a point and pierce bone with or without first drilling.

Referring to FIG. 8, it is a schematic side view of an embodiment of a device to maintain space between soft tissue and the periodontal defect. The device is pinnless and comprises a mesh 126 configured to extend over the periodontal defect and hold gingival tissue above the defect, the mesh has first end 124 configured to retain the mesh against at least a portion of the tooth 120.

In this embodiment shown, the first end of the mesh 124 is configured to have loops to be disposed around the tooth 120 on a tooth surface. The second ends 128 and 136 of the mesh are configured to receive anchoring members, shown as screws 132 and 130. The screw tips can pierce the bone 122 to hold the mesh in position. The screws can be inserted into loop or channel 136 of the mesh for ease of anchoring the membrane to bone. The mesh is attached to each screw and functions to further isolate and maintain space above the periodontal defect because of the increased surface area, as compared to embodiments with posts and/or pins. This increased space and isolation during the initial healing process will reduce migration of gingival epithelium cells, gingival connective tissue cells, and/or other soft tissue cells and enables the periodontal ligament to become re-established in a proper sequence resulting in a new periodontal attachment. It will be understood that although screws are shown, other anchoring members can be used for example, rods, pins, rivets, staples, eyelets, or any member than can hold the mesh or web to the bone.

In some embodiments, the mesh will allow certain cell ingrowth (e.g., alveolar bone cells, bone cementum cells, cementoblasts, periodontal ligament cells). The mesh will reduce passage of gingival epithelium cells, gingival connective tissue cells, other soft tissue cells, fibroblasts, mast cells, neutrophils, monocytes, lymphocytes, eosinophils, basophils, proteoglycans, and/or inflammatory components that may impair healing of the periodontal defect.

After the periodontal defect has healed, the gingival epithelium cells, and gingival connective tissue or other soft tissue will cover the mesh (e.g., usually in a few weeks or months after the device is placed over the defect). In a subsequent visit, the practitioner in a minimally invasive procedure can simply remove the screws and the mesh (if the mesh is not biodegradable) out of the now healed defect and there will be no need for subsequent surgeries that cut into the healed soft tissue to remove the device.

In some embodiments, a method is provided for treating a periodontal defect adjacent to a tooth, the method comprising separating soft tissue from at least a portion of the tooth located at the periodontal defect; providing a device comprising a rod having a body configured to extend over the periodontal defect and hold gingival tissue above the defect, the rod having a first end configured to retain the rod against at least a portion of the tooth and a second end implanted in at least a portion of bone adjacent to the periodontal defect; and placing the first end of the rod against at least the portion of the tooth and implanting the second end of the rod in at least the portion of the bone adjacent to the periodontal defect so as to extend the body over the periodontal defect and hold gingival tissue above the defect, wherein the body of the rod maintains space between gingival tissue and a periodontal ligament.

In some embodiments, a method is provided for treating a periodontal defect where the method comprises administering bone replacement material into the periodontal defect after separating soft tissue from at least a portion of the tooth located at the periodontal defect.

In some embodiments, a method is provided for treating a periodontal defect, using a rod comprising a pin having a first end having a channel where a suture is disposed in it, the suture configured to be fastened around the tooth and the second end of the pin configured to be implanted into the bone adjacent to the periodontal defect, where the method further comprises drilling a hole into the bone adjacent to the periodontal defect, fastening the suture around the tooth at the first end of the pin and implanting the second end of the pin into the bone to hold the pin in a position horizontally over the defect to maintain space between the gingival tissue and the periodontal ligament. Unlike prior art methods, the present method is a novel way of treating periodontal defects by placing the device next to the tooth.

### Bone Replacement Material

In some embodiments, to enhance bone growth at the periodontal defect, a bone replacement material can be used in the area. Bone replacement materials can include bone particles from fully mineralized bone, and demineralized bone particles and combinations thereof. The bone particles can be autograft, allograft, xenogenic, transgenic bone particles or a combination thereof.

In some embodiments, the bone replacement material includes bone cements. Bone cements are commonly provided in two or more components. The first component is usually a powder and the second component is usually in liquid form. Examples of bone cement materials include those based on acrylate materials which can react by polymerization to form acrylate polymers.

In some embodiments, the bone cement comprises powder that includes, for example, calcium phosphate based powders and poly-methyl-methacrylate based powders. Any of various osteoconductive powders, such as ceramics, calcium sulfate or calcium phosphate compounds, hydroxyapatite, magnesium and Si based cements, deproteinized bone, corals, and certain polymers, can alternatively or additionally be used in the bone cement.

Typically, bone cement can be formed by mixing a liquid acrylate monomer with a powder such as acrylate polymer using a mixing element, where the mixing can be accomplished by hand or machine. The resulting mixture has a paste or dough-like consistency. Typically, the components of the mixture react, involving polymerization of the acrylate monomer and copolymerization with the acrylate polymer particles. The viscosity of the cement composition increases during the reaction, resulting in a hard cement. The curing reaction of a bone cement material is generally exothermic.

Typically, the bone cement is prepared prior to injection by mixing bone-cement powder (e.g., poly-methyl-methacrylate (PMMA)), a liquid monomer (e.g., methyl-methacrylate monomer (MMA)), an x-ray contrast agent (e.g., barium sulfate), and an activator of the polymerization reaction (e.g., N,N-dimethyl-p-toluidine) to form a fluid mixture. Other additives including but not limited to stabilizers, drugs, fillers, dyes and fibers may also be included in the bone cement. Since the components react upon mixing, immediately leading to the polymerization, the components of bone cement should be kept separate from each other until the user is ready to form the desired bone cement. Once mixed, the user must work very quickly because the bone cement sets and hardens rapidly.

Other examples of bone cement compositions and/or their uses are discussed in US Patent Publication No. 20080109003, U.S. Pat. No. 7,138,442; U.S. Pat. No. 7,160,932; U.S. Pat. No. 7,014,633; U.S. Pat. No. 6,752,863; U.S. Pat. No. 6,020,396; U.S. Pat. No. 5,902,839; U.S. Pat. No. 4,910,259; U.S. Pat. No. 5,276,070; U.S. Pat. No. 5,795,922; U.S. Pat. No. 5,650,108; U.S. Pat. No. 6,984,063; U.S. Pat. No. 4,588,583; U.S. Pat. No. 4,902,728; U.S. Pat. No. 5,797,873; U.S. Pat. No. 6,160,033; and EP 0 701 824, the entire disclosures of which are herein incorporated by reference.

In some embodiments, other additives can be mixed with the bone replacement material and this includes bioactive substances. Thus, one or more bioactive substances can be combined with the bone replacement by soaking or immersing the bone replacement in a solution or dispersion of the desired bioactive substance(s). Bioactive substances include physiologically or pharmacologically active substances that act locally or systemically in the host. In certain applications, the bone cement can be used as a time-release drug delivery device for drugs or other bioactive substances that are to be delivered to the surgical site.

Bioactive substances which can be readily combined with the bone replacement material, e.g., collagen, insoluble collagen derivatives, etc., and soluble solids and/or liquids dissolved therein; antiviricides, particularly those effective against HIV and hepatitis; antimicrobials and/or antibiotics such as erythromycin, bacitracin, neomycin, penicillin, polymycin B, tetracyclines, biomycin, chloromycetin, and streptomycins, cefazolin, ampicillin, azactam, tobramycin, clindamycin or gentamicin, etc.; biocidal/biostatic sugars such as dextran, glucose, etc.; amino acids; peptides; vitamins; inorganic elements; co-factors for protein synthesis; hormones; endocrine tissue or tissue fragments; synthesizers; enzymes such as collagenase, peptidases, oxidases, etc.; polymer cell scaffolds with parenchymal cells; angiogenic agents or polymeric carriers containing such agents; collagen lattices; antigenic agents; cytoskeletal agents; cartilage fragments; living cells such as chondrocytes, bone marrow cells, mesenchymal stem cells, natural extracts, genetically engineered living cells or otherwise modified living cells; DNA delivered by plasmid or viral vectors; tissue transplants; demineralized bone powder; autogenous tissues such as blood, serum, soft tissue, bone marrow, etc.; bioadhesives, bone morphogenic proteins (BMPs); osteoinductive factor; fibronectin (FN), osteonectin (ON); endothelial cell growth factor (ECGF); cementum attachment extracts (CAE); ketanserin; human growth hormone (HGH); animal growth hormones; epidermal growth factor (EGF); interleukin-1 (IL-1); human alpha thrombin; transforming growth factor (TGF-beta); insulin-like growth factor (IGF-1); platelet derived growth factors (PDGF); fibroblast growth factors (FGF, bFGF, etc.); periodontal ligament chemotactic factor (PDLGF); somatotropin; bone digestors; antitumor agents; immuno-suppressants; permeation enhancers, e.g., fatty acid esters such as laureate, myristate and stearate monoesters of polyethylene glycol, enamine derivatives, alpha-keto aldehydes, etc.; or nucleic acids. When employed, the total amount of bioactive substance can represent from about 0.1 to about 60 weight percent of the bone replacement material.

In some embodiments, the bioactive agent is mixed before, with, or after the bone replacement material is added to the periodontal defect. In some embodiments, the bioactive agent comprises the family of proteins known as the transforming growth factor-beta (TGFβ) superfamily of proteins, which includes the activins, inhibins, or bone morphogenetic proteins (BMPs). In some embodiments, the active agent includes at least one protein from the subclass of proteins known generally as BMPs. BMPs have been shown to possess a wide range of growth and differentiation activities, including induction of the growth and differentiation of bone, connective, kidney, heart, and neuronal tissues. See, for example, descriptions of BMPs in the following publications: BMP-2, BMP-3, BMP-4, BMP-5, BMP-6, and BMP-7 (disclosed, for example, in U.S. Pat. No. 5,013,649 (BMP-2 and BMP-4); U.S. Pat. No. 5,116,738 (BMP-3); U.S. Pat. No. 5,106,748 (BMP-5); U.S. Pat. No. 5,187,076 (BMP-6); and U.S. Pat. No. 5,141,905 (BMP-7)); BMP-8 (disclosed in PCT WO 91/18098); BMP-9 (disclosed in PCT WO 93/00432); BMP-10 (disclosed in PCT WO 94/26893); BMP-11 (disclosed in PCT WO 94/26892); BMP-12 or BMP-13 (disclosed in PCTWO 95/16035); BMP-15 (disclosed in U.S. Pat. No. 5,635,372); BMP-16 (disclosed in U.S. Pat. No. 6,331,612); MP52/GDF-5 (disclosed in PCT WO 93/16099); or BMP-17 or BMP-18 (disclosed in U.S. Pat. No. 6,027,917). The entire disclosure of these references is herein incorporated by reference. Other TGF-proteins that may be useful as the active agent of the bone cement paste include Vgr-2 and any of the growth and differentiation factors (GDFs), such as, for example, GDF-5.

A subset of BMPs that may be used in certain embodiments includes BMP-2, BMP-4, BMP-5, BMP-6, BMP-7, BMP-8, BMP-9, BMP-10, BMP-11, BMP-12 or BMP-13. In some embodiments, the composition contains two or more active agents (e.g., BMP-2 and BMP-4). Other BMPs and TGF-proteins may also be used.

The active agent may be recombinantly produced, or purified from another source. The active agent, if a TGFβ protein such as a BMP, or other dimeric protein, may be homodimeric, or may be heterodimeric with other BMPs (e.g., a heterodimer composed of one monomer each of BMP-2 and BMP-6) or with other members of the TGF-β superfamily, such as activins, inhibins and TGF-β (e.g., a heterodimer composed of one monomer each of a BMP and a related member of the TGF-β superfamily). Examples of such heterodimeric proteins are described, for example in published PCT Patent Application WO 93/09229.

In some embodiments, the amount of growth factor, (e.g., bone morphogenic protein) may be sufficient to cause bone growth. In some embodiments, the growth factor is rhBMP-2 and is contained in the bone replacement material in an amount of from 1 to 2 mg per cubic centimeter of the bone replacement material. In some embodiments, the amount of rhBMP-2 morphogenic protein is from 2.0 to 2.5 mg per cubic centimeter (cc) of the bone replacement material.

In some embodiments, the growth factor is supplied in a liquid carrier (e.g., an aqueous buffered solution). Exemplary aqueous buffered solutions include, but are not limited to, TE, HEPES (2-[4-(2-hydroxyethyl)-1-piperazinyl]ethanesulfonic acid), MES (2-morpholinoethanesulfonic acid), sodium acetate buffer, sodium citrate buffer, sodium phosphate buffer, a Tris buffer (e.g., Tris-HCL), phosphate buffered saline (PBS), sodium phosphate, potassium phosphate, sodium chloride, potassium chloride, glycerol, calcium chloride or a combination thereof. In various embodiments, the buffer concentration can be from about 1 mM to 100 mM. In some embodiments, the BMP-2 is provided in a vehicle (including a buffer) containing sucrose, glycine, L-glutamic acid, sodium chloride, and/or polysorbate 80.

The bone replacement material may be mixed with additional therapeutic agents. Exemplary therapeutic agents include but are not limited to IL-1 inhibitors, such Kineret® (anakinra), which is a recombinant, non-glycosylated form of the human interleukin-1 receptor antagonist (IL-1Ra), or AMG 108, which is a monoclonal antibody that blocks the action of IL-1. Therapeutic agents also include excitatory amino acids such as glutamate and aspartate, antagonists or inhibitors of glutamate binding to NMDA receptors, AMPA receptors, and/or kainate receptors. Interleukin-1 receptor antagonists, thalidomide (a TNF-α release inhibitor), thalidomide analogues (which reduce TNF-α production by macrophages), quinapril (an inhibitor of angiotensin II, which upregulates TNF-α), interferons such as IL-11 (which modulate TNF-α receptor expression), and aurin-tricarboxylic acid (which inhibits TNF-α), may also be useful as therapeutic agents for reducing inflammation. It is further contemplated that where desirable a pegylated form of the above may be used. Examples of still other therapeutic agents include NF kappa B inhibitors such as antioxidants, such as dithiocarbamate, and other compounds, such as, for example, sulfasalazine.

Examples of therapeutic agents suitable for use also include, but are not limited to, an anti-inflammatory agent, or analgesic agent. Anti-inflammatory agents include, but are not limited to, apazone, celecoxib, diclofenac, diflunisal, enolic acids (piroxicam, meloxicam), etodolac, fenamates (mefenamic acid, meclofenamic acid), gold, ibuprofen, indomethacin, ketoprofen, ketorolac, nabumetone, naproxen, nimesulide, salicylates, sulfasalazine [2-hydroxy-5-[-4-[C2-pyridinylamino)sulfonyl]azo]benzoic acid, sulindac, tepoxalin, and tolmetin; as well as antioxidants, such as dithiocarbamate, steroids, such as cortisol, cortisone, hydrocortisone, fludrocortisone, prednisone, prednisolone, methylprednisolone, triamcinolone, betamethasone, dexamethasone, beclomethasone, fluticasone or a combination thereof.

Suitable analgesic agents include, but are not limited to, acetaminophen, bupivicaine, fluocinolone, lidocaine, opioid analgesics such as buprenorphine, butorphanol, dextromoramide, dezocine, dextropropoxyphene, diamorphine, fentanyl, alfentanil, sufentanil, hydrocodone, hydromorphone, ketobemidone, levomethadyl, mepiridine, methadone, morphine, nalbuphine, opium, oxycodone, papaveretum, pentazocine, pethidine, phenoperidine, piritramide, dextropropoxyphene, remifentanil, tilidine, tramadol, codeine, dihydrocodeine, meptazinol, dezocine, eptazocine, flupirtine, amitriptyline, carbamazepine, gabapentin, pregabalin, or a combination thereof.

In some embodiments, a statin may be used. Statins include, but is not limited to, atorvastatin, simvastatin, pravastatin, cerivastatin, mevastatin (see U.S. Pat. No. 3,883,140, the entire disclosure is herein incorporated by reference), velostatin (also called synvinolin; see U.S. Pat. Nos. 4,448,784 and 4,450,171 these entire disclosures are herein incorporated by reference), fluvastatin, lovastatin, rosuvastatin and fluindostatin (Sandoz XU-62-320), dalvastain (EP Appln. Publn. No. 738510 A2, the entire disclosure is herein incorporated by reference), eptastatin, pitavastatin, or pharmaceutically acceptable salts thereof or a combination thereof. In various embodiments, the statin may comprise mixtures of (+) R and (−)-S enantiomers of the statin. In various embodiments, the statin may comprise a 1:1 racemic mixture of the statin.

In some embodiments, the bone replacement material can comprise antimicrobial agents. Antimicrobial agents to treat infection include by way of example and not limitation, antiseptic agents, antibacterial agents; quinolones and in particular fluoroquinolones (e.g., norfloxacin, ciprofloxacin, lomefloxacin, ofloxacin, etc.), aminoglycosides (e.g., gentamicin, tobramycin, etc.), glycopeptides (e.g., vancomycin, etc.), lincosamides (e.g., clindamycin), cephalosporins (e.g., first, second, third generation) and related beta-lactams, macrolides (e.g., azithromycin, erythromycin, etc.), nitroimidazoles (e.g., metronidazole), penicillins, polymyxins, tetracyclines, or combinations thereof.

Some exemplary antimicrobial agents include, by way of illustration and not limitation, acedapsone; acetosulfone sodium; alamecin; alexidine; amdinocillin; amdinocillin pivoxil; amicycline; amifloxacin; amifloxacin mesylate; amikacin; amikacin sulfate; aminosalicylic acid; aminosalicylate sodium; amoxicillin; amphomycin; ampicillin; ampicillin sodium; apalcillin sodium; apramycin; aspartocin; astromicin sulfate; avilamycin; avoparcin; azithromycin; azlocillin; azlocillin sodium; bacampicillin hydrochloride; bacitracin; bacitracin methylene disalicylate; bacitracin zinc; bambermycins; benzoylpas calcium; berythromycin; betamicin sulfate; biapenem; biniramycin; biphenamine hydrochloride; bispyrithione magsulfex; butikacin; butirosin sulfate; capreomycin sulfate; carbadox; carbenicillin disodium; carbenicillin indanyl sodium; carbenicillin phenyl sodium; carbenicillin potassium; carumonam sodium; cefaclor; cefadroxil; cefamandole; cefamandole nafate; cefamandole sodium; cefaparole; cefatrizine; cefazaflur sodium; cefazolin; cefazolin sodium; cefbuperazone; cefdinir; cefepime; cefepime hydrochloride; cefetecol; cefixime; cefmenoxime hydrochloride; cefmetazole; cefmetazole sodium; cefonicid monosodium; cefonicid sodium; cefoperazone sodium; ceforanide; cefotaxime sodium; cefotetan; cefotetan disodium; cefotiam hydrochloride; cefoxitin; cefoxitin sodium; cefpimizole; cefpimizole sodium; cefpiramide; cefpiramide sodium; cefpirome sulfate; cefpodoxime proxetil; cefprozil; cefroxadine; cefsulodin sodium; ceftazidime; ceftibuten; ceftizoxime sodium; ceftriaxone sodium; cefuroxime; cefuroxime axetil; cefuroxime pivoxetil; cefuroxime sodium; cephacetrile sodium; cephalexin; cephalexin hydrochloride; cephaloglycin; cephaloridine; cephalothin sodium; cephapirin sodium; cephradine; cetocycline hydrochloride; cetophenicol; chloramphenicol; chloramphenicol palmitate; chloramphenicol pantothenate complex; chloramphenicol sodium succinate; chlorhexidine phosphanilate; chloroxylenol; chlortetracycline bisulfate; chlortetracycline hydrochloride; cinoxacin; ciprofloxacin; ciprofloxacin hydrochloride; cirolemycin; clarithromycin; clinafloxacin hydrochloride; clindamycin; clindamycin hydrochloride; clindamycin palmitate hydrochloride; clindamycin phosphate; clofazimine; cloxacillin benzathine; cloxacillin sodium; chlorhexidine, cloxyquin; colistimethate sodium; colistin sulfate; coumermycin; coumermycin sodium; cyclacillin; cycloserine; dalfopristin; dapsone; daptomycin; demeclocycline; demeclocycline hydrochloride; demecycline; denofungin; diaveridine; dicloxacillin; dicloxacillin sodium; dihydrostreptomycin sulfate; dipyrithione; dirithromycin; doxycycline; doxycycline calcium; doxycycline fosfatex; doxycycline hyclate; droxacin sodium; enoxacin; epicillin; epitetracycline hydrochloride; erythromycin; erythromycin acistrate; erythromycin estolate; erythromycin ethylsuccinate; erythromycin gluceptate; erythromycin lactobionate; erythromycin propionate; erythromycin stearate; ethambutol hydrochloride; ethionamide; fleroxacin; floxacillin; fludalanine; flumequine; fosfomycin; fosfomycin tromethamine; fumoxicillin; furazolium chloride; furazolium tartrate; fusidate sodium; fusidic acid; ganciclovir and ganciclovir sodium; gentamicin sulfate; gloximonam; gramicidin; haloprogin; hetacillin; hetacillin potassium; hexedine; ibafloxacin; imipenem; isoconazole; isepamicin; isoniazid; josamycin; kanamycin sulfate; kitasamycin; levofuraltadone; levopropylcillin potassium; lexithromycin; lincomycin; lincomycin hydrochloride; lomefloxacin; lomefloxacin hydrochloride; lomefloxacin mesylate; loracarbef; mafenide; meclocycline; meclocycline sulfosalicylate; megalomicin potassium phosphate; mequidox; meropenem; methacycline; methacycline hydrochloride; methenamine; methenamine hippurate; methenamine mandelate; methicillin sodium; metioprim; metronidazole hydrochloride; metronidazole phosphate; mezlocillin; mezlocillin sodium; minocycline; minocycline hydrochloride; mirincamycin hydrochloride; monensin; monensin sodiumr; nafcillin sodium; nalidixate sodium; nalidixic acid; natainycin; nebramycin; neomycin palmitate; neomycin sulfate; neomycin undecylenate; netilmicin sulfate; neutramycin; nifuiradene; nifuraldezone; nifuratel; nifuratrone; nifurdazil; nifurimide; nifiupirinol; nifurquinazol; nifurthiazole; nitrocycline; nitrofurantoin; nitromide; norfloxacin; novobiocin sodium; ofloxacin; onnetoprim; oxacillin and oxacillin sodium; oximonam; oximonam sodium; oxolinic acid; oxytetracycline; oxytetracycline calcium; oxytetracycline hydrochloride; paldimycin; parachlorophenol; paulomycin; pefloxacin; pefloxacin mesylate; penamecillin; penicillins such as penicillin g benzathine, penicillin g potassium, penicillin g procaine, penicillin g sodium, penicillin v, penicillin v benzathine, penicillin v hydrabamine, and penicillin v potassium; pentizidone sodium; phenyl aminosalicylate; piperacillin sodium; pirbenicillin sodium; piridicillin sodium; pirlimycin hydrochloride; pivampicillin hydrochloride; pivampicillin pamoate; pivampicillin probenate; polymyxin b sulfate; porfiromycin; propikacin; pyrazinamide; pyrithione zinc; quindecamine acetate; quinupristin; racephenicol; ramoplanin; ranimycin; relomycin; repromicin; rifabutin; rifametane; rifamexil; rifamide; rifampin; rifapentine; rifaximin; rolitetracycline; rolitetracycline nitrate; rosaramicin; rosaramicin butyrate; rosaramicin propionate; rosaramicin sodium phosphate; rosaramicin stearate; rosoxacin; roxarsone; roxithromycin; sancycline; sanfetrinem sodium; sarmoxicillin; sarpicillin; scopafungin; sisomicin; sisomicin sulfate; sparfloxacin; spectinomycin hydrochloride; spiramycin; stallimycin hydrochloride; steffimycin; streptomycin sulfate; streptonicozid; sulfabenz; sulfabenzamide; sulfacetamide; sulfacetamide sodium; sulfacytine; sulfadiazine; sulfadiazine sodium; sulfadoxine; sulfalene; sulfamerazine; sulfameter; sulfamethazine; sulfamethizole; sulfamethoxazole; sulfamonomethoxine; sulfamoxole; sulfanilate zinc; sulfanitran; sulfasalazine; sulfasomizole; sulfathiazole; sulfazamet; sulfisoxazole; sulfisoxazole acetyl; sulfisboxazole diolamine; sulfomyxin; sulopenem; sultamricillin; suncillin sodium; talampicillin hydrochloride; teicoplanin; temafloxacin hydrochloride; temocillin; tetracycline; tetracycline hydrochloride; tetracycline phosphate complex; tetroxoprim; thiamphenicol; thiphencillin potassium; ticarcillin cresyl sodium; ticarcillin disodium; ticarcillin monosodium; ticlatone; tiodonium chloride; tobramycin; tobramycin sulfate; tosufloxacin; trimethoprim; trimethoprim sulfate; trisulfapyrimidines; troleandomycin; trospectomycin sulfate; tyrothricin; vancomycin; vancomycin hydrochloride; virginiamycin; zorbamycin; or combinations thereof.

One method of making the bone replacement material includes adding the powder to the container and adding the liquid and other components to the container and mixing them by hand or machine until the desired consistency of the bone replacement material is reached. Optionally, the mixture can include one or more other optional components such as any of binders, fillers, plasticizers, biostatic/biocidal agents, surface active agents, bioactive substances, or reinforcing components, graft material, cells (e.g., alveolar bone cells, bone cementum cells, cementoblasts, periodontal ligament cells, etc.). A syringe is then filled with the bone replacement material and then delivered to the periodontal defect as discussed above.

### Kits

One or more devices (e.g., rods, pins, posts, meshes, webs, screws) may be placed in a kit, which may be sterilizable by radiation in a terminal sterilization step in the final packaging. Terminal sterilization of a product provides greater assurance of sterility than from processes such as an aseptic process, which require individual product components to be sterilized separately and the final package assembled in a sterile environment. In various embodiments, gamma radiation is used in the terminal sterilization step, which involves utilizing ionizing energy from gamma rays that penetrates deeply in the device. Gamma rays are highly effective in killing microorganisms, they leave no residues nor have sufficient energy to impart radioactivity to the device. Gamma rays can be employed when the device is in the package and gamma sterilization does not require high pressures or vacuum conditions, thus, package seals and other components are not stressed. In addition, gamma radiation eliminates the need for permeable packaging materials.

In some embodiments, the device may be packaged in a moisture resistant kit and then terminally sterilized by gamma irradiation. In use the practitioner removes the one or all components from the sterile package for use. In various embodiments, electron beam (e-beam) radiation may be used to sterilize one or more components of the device. E-beam radiation comprises a form of ionizing energy, which is generally characterized by low penetration and high-dose rates. E-beam irradiation is similar to gamma processing in that it alters various chemical and molecular bonds on contact, including the reproductive cells of microorganisms. Beams produced for e-beam sterilization are concentrated, highly-charged streams of electrons generated by the acceleration and conversion of electricity.

Other methods may also be used to sterilize delivery device and/or one or more of its components (e.g., rods, pins, posts, meshes, webs, screws), including, but not limited to, gas sterilization, such as, for example, with ethylene oxide or steam sterilization.

In various embodiments, a kit is provided comprising sterile or non-sterile devices (e.g., rods, pins, posts, meshes, webs, screws). The kit may include additional parts along with the devices combined together to be used with it (e.g., wipes, needles, syringes, etc.). The kit may include gloves, drapes, wound dressings and other procedural supplies for maintaining sterility of the delivery process, as well as an instruction booklet, DVDs, or CDs, which may include a chart that shows how to use the device.

It will be apparent to those skilled in the art that various modifications and variations can be made to various embodiments described herein without departing from the spirit or scope of the teachings herein. Thus, it is intended that various embodiments cover other modifications and variations of various embodiments within the scope of the present teachings.

What is claimed is:

1. A device for maintaining space to treat a periodontal defect adjacent to a tooth, the device comprising a supporting structure having a body configured to extend over the periodontal defect and hold gingival tissue above the defect, the supporting structure having a first end configured to retain the supporting structure against at least a portion of the tooth and a second end implanted in or on at least a portion of bone adjacent to the periodontal defect, wherein the body of the supporting structure maintains space between at least gingival tissue and a periodontal ligament.

2. A device for maintaining space according to claim 1, wherein the supporting structure comprises a pin having a first and second end, the first end of the pin comprises a channel having a suture disposed therein, the suture configured to be fastened around the tooth and the second end of the pin comprises a point configured to be placed into or on the bone adjacent to the periodontal defect to hold the pin in a position horizontally over the defect to maintain space between the gingival tissue and the periodontal ligament.

3. A device according to claim 2, wherein the pin can be removed without cutting the gingival tissue once the periodontal ligament is regenerated and the gingival tissue comprises gingival epithelium and gingival connective tissue.

4. A device according to claim 1, wherein the tooth has a post disposed on its surface, the post configured to receive the first end of the supporting structure and the first end of the supporting structure disposed in or on the post to hold the rod in position or wherein the supporting structure is disposed on a surface of the tooth to hold the supporting structure in position.

5. A device according to claim 1, wherein the device comprises at least two supporting structures disposed on a surface of the tooth to hold the supporting structure in position.

6. A device according to claim 1, wherein the supporting structure comprises a mesh or web, the mesh or web configured to retain gingival epithelium cells and gingival connective tissue up and out of the periodontal defect and away from regenerating periodontal ligament, cementum and bone.

7. A device according to claim 4, wherein the supporting structure is a pin and the pin or post is attached to the tooth surface by an adhesive.

8. A device according to claim 1, wherein the first end of the supporting structure is attached to a tooth surface by an adhesive.

9. A device according to claim 1, wherein bone replacement material is disposed in the periodontal defect.

10. A device according to claim 1, wherein the supporting structure comprises a plurality of struts contacting the first end of the supporting structure and running over the periodontal defect to the second end of the supporting structure, the plurality of struts being flexible and contacting the bone adjacent to the second end of the supporting structure so as to increase a surface area for holding the gingival tissue.

11. A device for maintaining space to treat a periodontal defect adjacent to a tooth, the device comprising a mesh or suture having a body configured to extend over the periodontal defect and hold gingival tissue above the defect, the mesh or suture having a first end configured to retain the mesh or suture against at least a portion of the tooth and a second end having configured to be implanted in or on at least a portion of bone adjacent to the periodontal defect, wherein the body of the mesh or suture maintains space between gingival tissue and a periodontal ligament.

12. A device for maintaining space according to claim 12, wherein the first end or second end or both first end and second end are held in position by anchoring members or wherein the first end or second end or both first end and second end are held in position by adhesive which is disposed on the tooth or bone.

13. A device for maintaining space according to claim 12, wherein the mesh is configured to retain gingival epithelium cells and gingival connective tissue up and out of the periodontal defect and away from regenerating periodontal ligament cementum and bone.

14. A device for maintaining space according to claim 12, wherein the first end of the mesh comprises a suture that is fastened around the tooth and the anchoring members comprise screws disposed in each channel, the screws having points that pierce the bone and anchor the second end of the mesh to the bone.

15. A device according to claim 12, wherein the mesh can be removed without cutting the gingival tissue once the periodontal ligament and/or bone is regenerated and the gingival tissue comprises gingival epithelium and gingival connective tissue.

16. A method for treating a periodontal defect adjacent to a tooth, the method comprising
separating soft tissue from at least a portion of the tooth located at the periodontal defect;
providing a device comprising a supporting structure having a body configured to extend over the periodontal defect and hold gingival tissue above the defect, the supporting structure having a first end configured to retain the supporting structure against at least a portion of the tooth and a second end implanted in or on at least a portion of bone adjacent to the periodontal defect; and
placing the first end of the supporting structure against at least the portion of the tooth and implanting the second end of the rod in or on at least the portion of the bone adjacent to the periodontal defect so as to extend the body over the periodontal defect and hold gingival tissue above the defect, wherein the body of the supporting structure maintains space between gingival tissue and a periodontal ligament.

17. A method for treating a periodontal defect according to claim 16, further comprising removing the device from the periodontal defect after the defect is healed without cutting into soft tissue.

18. A method for treating a periodontal defect according to claim 16, further comprising administering bone replacement material into the periodontal defect after separating soft tissue from at least a portion of the tooth located at the periodontal defect.

19. A method for treating a periodontal defect according to claim 16, wherein the supporting structure comprises a pin having a first and second end, the first end of the pin comprising a channel having a suture disposed therein, the suture configured to be fastened around the tooth and the second end of the pin comprising a point configured to pierce into the bone adjacent to the periodontal defect to hold the pin in a position horizontally over the defect to maintain space between the gingival tissue and the periodontal ligament.

20. A method for treating a periodontal defect according to claim 16, wherein the supporting structure comprises a pin having a first end and a second end, the first end of the pin comprises a channel having a suture disposed therein, the suture configured to be fastened around the tooth and the second end of the pin configured to be implanted into the bone adjacent to the periodontal defect, wherein the method further comprises drilling a hole into the bone adjacent to the periodontal defect, fastening the suture around the tooth at the first end of the pin and implanting the second end of the pin into the bone to hold the pin in a position horizontally over the defect to maintain space between the gingival tissue and the periodontal ligament.
